(19) United States
(12) Patent Application Publication
(10) Pub. No.: US 2025/0089038 A1
(43) Pub. Date: Mar. 13, 2025

(54) METHODS AND APPARATUSES FOR SCHEDULING TERMINAL DEVICE

(71) Applicant: Telefonaktiebolaget LM Ericsson (publ), Stockholm (SE)

(72) Inventor: Huichen WANG, Beijing (CN)

(21) Appl. No.: 18/729,379

(22) PCT Filed: Jan. 26, 2022
(86) PCT No.: PCT/CN2022/074087

§ 371 Date: Jul. 16, 2024

(51) Int. Cl. H04W 72/121; H04W 72/04; H04W 72/563

(52) U.S. Cl. CPC H04W 72/121; H04W 72/04; H04W 72/563

(57) ABSTRACT

A first base station schedules at least part of a plurality of terminal devices which require data transmissions using carrier aggregation (CA) of a primary cell of the first base station and a secondary cell of a second base station, based on information related to a first radio resource partition (RRP) configuration and/or a second RRP configuration. The first/second RRP configuration indicates, for multiple first/second operators related to the first/second base station, corresponding shares partitioned from target resources available at the first/second base station. The first base station sends a result of the scheduling to the second base station. Total resources available at the first/second base station are divided into a first part of resources dedicated for initial transmissions and a second part of resources dedicated for retransmissions. The first/second RRP configuration is applicable only to at least part of the first part of resources.

### TECHNICAL FIELD

Embodiments of the disclosure generally relate to communication, and, more particularly, to methods and apparatuses for scheduling terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

In a shared network, shared spectrum between two or more operators is required by the operators. To be able to grant their requests for a fair share between the operators, radio resource partitioning is developed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for scheduling terminal device. In particular, one of the problems to be solved by the disclosure is how to allocate resources among multiple operators flexibly when radio resource partition (RRP) is deployed along with carrier aggregation (CA). Another problem to be solved by the disclosure is that retransmission resources are impacted by radio resource partition (RRP) configuration in the existing solution.

According to a first aspect of the disclosure, there is provided a method performed by a first base station. The method may comprise scheduling at least part of a plurality of terminal devices which require data transmissions using carrier aggregation (CA) of a primary cell of the first base station and a secondary cell of a second base station, based on information related to a first radio resource partition (RRP) configuration and/or a second RRP configuration. The first/second RRP configuration may indicate, for multiple first/second operators related to the first/second base station, corresponding shares partitioned from target resources available at the first/second base station. The method may further comprise sending a result of the scheduling to the second base station. Total resources available at the first/second base station may be divided into a first part of resources dedicated for initial transmissions and a second part of resources dedicated for retransmissions. The first/second RRP configuration may be applicable only to at least part of the first part of resources.

In this way, the retransmission resources can be protected from being impacted by the RRP configuration.

In an embodiment of the disclosure, the first part of resources may be divided into at least two partitions which comprise a base partition having a first priority and a normal partition having a second priority. The first priority may be the highest priority among priorities of the at least two partitions. The first/second RRP configuration may be applicable to the normal partition and not applicable to the base partition.

In an embodiment of the disclosure, the information related to the second RRP configuration may be received from the second base station and comprise a first indicator indicating whether resource partitioning based on the second RRP configuration is requested by the second base station with respect to external resources for external usage of the CA. The information related to the first RRP configuration may be maintained at the first base station and comprise a second indicator indicating whether the primary cell of the first base station is configured to follow or ignore a resource partitioning request from the secondary cell of the second base station.

In an embodiment of the disclosure, scheduling at least part of the plurality of terminal devices may comprise sorting the data transmissions required by the plurality of terminal devices. Scheduling at least part of the plurality of terminal devices may further comprise determining which terminal devices can be allocated with external resources indicated by the second base station for external usage of the CA.

In an embodiment of the disclosure, when the multiple first operators are different than the multiple second operators and the primary cell is configured to follow a resource partitioning request from the secondary cell, one or more terminal devices whose operator is indicated in the first RRP configuration but not indicated in the second RRP configuration, may be sorted with a lowest priority. At least one of the one or more terminal devices may be allocated with resources from the base partition in the external resources. The result of the scheduling sent to the second base station may comprise, for the at least one terminal device, an identifier (ID) identifying the base partition in the external resources.

In an embodiment of the disclosure, when the primary cell is configured to ignore a resource partitioning request from the secondary cell, at least one of the plurality of terminal devices may be allocated with resources from the base partition in the external resources. The result of the scheduling sent to the second base station may comprise, for the at least one terminal device, an ID identifying the base partition in the external resources.

In an embodiment of the disclosure, the share of a first/second operator may comprise at least one of: an expected share that is expected to be partitioned for the first/second operator from the target resources; and a maximum share that can be partitioned for the first/second operator from the target resources. The maximum share of the first/second operator may be greater than the expected share of the first/second operator and smaller than or equal to 100%.

In an embodiment of the disclosure, when the multiple first operators are the same as the multiple second operators and the primary cell is configured to follow a resource partitioning request from the secondary cell, at least one of the plurality of terminal devices may be allocated with resources from the normal partition in the external resources. The at least one terminal device may be determined based on first operator(s) serving the plurality of terminal devices and maximum share(s) of corresponding second operator(s) which are same as the first operator(s).

In an embodiment of the disclosure, when the multiple first operators are different than the multiple second operators and the primary cell is configured to follow a resource partitioning request from the secondary cell, at least one terminal device, from one or more devices whose operator is indicated in the first and second RRP configurations, may be allocated with resources from the normal partition in the external resources. The at least one terminal device may be determined based on first operator(s) serving the one or more terminal devices and maximum share(s) of corresponding second operator(s) which are same as the first operator(s).

In an embodiment of the disclosure, the method may further comprise maintaining, for each first operator which is same as a corresponding second operator, a third indicator indicating whether over-allocation of external resources than the expected share of the second operator is performed for the first operator in current scheduling event. In a next scheduling event, terminal device(s) served by the first operator for which over-allocation of external resources is performed may be sorted with lower priorities than terminal device(s) served by the first operator for which no over-allocation of external resources is performed.

According to a second aspect of the disclosure, there is provided a method performed by a second base station. The method may comprise sending, to a first base station, information related to a second RRP configuration. The second RRP configuration may indicate, for multiple second operators related to the second base station, corresponding shares partitioned from target resources available at the second base station. The method may further comprise receiving, from the first base station, a result of scheduling for one or more terminal devices which require data transmissions using CA of a primary cell of the first base station and a secondary cell of the second base station. Total resources available at the second base station may be divided into a first part of resources dedicated for initial transmissions and a second part of resources dedicated for retransmissions. The second RRP configuration may be applicable only to at least part of the first part of resources.

In this way, the retransmission resources can be protected from being impacted by the RRP configuration.

In an embodiment of the disclosure, the first part of resources may be divided into at least two partitions which comprise a base partition having a first priority and a normal partition having a second priority. The first priority may be the highest priority among priorities of the at least two partitions. The second RRP configuration may be applicable to the normal partition and not applicable to the base partition.

In an embodiment of the disclosure, the information related to the second RRP configuration may comprise a first indicator indicating whether resource partitioning based on the second RRP configuration is requested by the second base station with respect to external resources for external usage of the CA.

In an embodiment of the disclosure, the share of a second operator may comprise at least one of: an expected share that is expected to be partitioned for the second operator from the target resources; and a maximum share that can be partitioned for the second operator from the target resources. The maximum share of the second operator may be greater than the expected share of the second operator and smaller than or equal to 100%.

In an embodiment of the disclosure, the method may further comprise scheduling at least part of a plurality of terminal devices requiring data transmissions which use local resources available at the second base station, based on second operator(s) serving the plurality of terminal devices and corresponding maximum share(s) of the second operator(s) indicated by the second RRP configuration.

In an embodiment of the disclosure, the method may further comprise maintaining, for each of the multiple second operators, a third indicator indicating whether over-allocation of local resources than the expected share of the second operator is performed for the second operator in current scheduling event. In a next scheduling event, terminal device(s) served by the second operator for which over-allocation of local resources is performed may be scheduled with lower priorities than terminal device(s) served by the second operator for which no over-allocation of local resources is performed.

According to a third aspect of the disclosure, there is provided a method performed by a base station. The method may comprise scheduling at least part of a plurality of terminal devices requiring data transmissions, based on a RRP configuration that indicates, for multiple operators related to the base station, corresponding shares partitioned from target resources available at the base station. Total resources available at the base station may be divided into a first part of resources dedicated for initial transmissions and a second part of resources dedicated for retransmissions. The RRP configuration may be applicable only to at least part of the first part of resources.

In this way, the retransmission resources can be protected from being impacted by the RRP configuration.

In an embodiment of the disclosure, the first part of resources may be divided into at least two partitions which comprise a base partition having a first priority and a normal partition having a second priority. The first priority may be the highest priority among priorities of the at least two partitions. The RRP configuration may be applicable to the normal partition and not applicable to the base partition.

In an embodiment of the disclosure, the share of an operator may comprise at least one of: an expected share that is expected to be partitioned for the operator from the target resources; and a maximum share that can be partitioned for the operator from the target resources. The maximum share of the operator may be greater than the expected share of the operator and smaller than or equal to 100%.

In an embodiment of the disclosure, scheduling at least part of the plurality of terminal devices may comprise sorting the data transmissions required by the plurality of terminal devices. Scheduling at least part of the plurality of terminal devices may further comprise determining which terminal devices can be allocated with resources, based on operator(s) serving the plurality of terminal devices and corresponding maximum share(s) of the operator(s) indicated by the RRP configuration.

In an embodiment of the disclosure, the method may further comprise maintaining, for each of the multiple operators, an indicator indicating whether over-allocation of resources than the expected share of the operator is performed for the operator in current scheduling event. In a next scheduling event, terminal device(s) served by the operator for which over-allocation of resources is performed may be sorted with lower priorities than terminal device(s) served by the operator for which no over-allocation of resources is performed.

According to a fourth aspect of the disclosure, there is provided a first base station. The first base station may comprise at least one processor and at least one memory. The at least one memory may contain instructions executable by the at least one processor, whereby the first base station may be operative to schedule at least part of a plurality of terminal devices which require data transmissions using CA of a primary cell of the first base station and a secondary cell of a second base station, based on information related to a first RRP configuration and/or a second RRP configuration. The first/second RRP configuration may indicate, for multiple first/second operators related to the first/second base station, corresponding shares partitioned from target resources available at the first/second base station. The first base station may be further operative to send a result of the scheduling to the second base station. Total resources available at the first/second base station may be divided into a first part of resources dedicated for initial transmissions and a second part of resources dedicated for retransmissions. The first/second RRP configuration may be applicable only to at least part of the first part of resources.

In an embodiment of the disclosure, the first base station may be operative to perform the method according to the above first aspect.

According to a fifth aspect of the disclosure, there is provided a second base station. The second base station may comprise at least one processor and at least one memory. The at least one memory may contain instructions executable by the at least one processor, whereby the second base station may be operative to send, to a first base station, information related to a second RRP configuration. The second RRP configuration may indicate, for multiple second operators related to the second base station, corresponding shares partitioned from target resources available at the second base station. The second base station may be further operative to receive, from the first base station, a result of scheduling for one or more terminal devices which require data transmissions using CA of a primary cell of the first base station and a secondary cell of the second base station. Total resources available at the second base station may be divided into a first part of resources dedicated for initial transmissions and a second part of resources dedicated for retransmissions. The second RRP configuration may be applicable only to at least part of the first part of resources.

In an embodiment of the disclosure, the second base station may be operative to perform the method according to the above second aspect.

According to a sixth aspect of the disclosure, there is provided a base station. The base station may comprise at least one processor and at least one memory. The at least one memory may contain instructions executable by the at least one processor, whereby the base station may be operative to schedule at least part of a plurality of terminal devices requiring data transmissions, based on a RRP configuration that indicates, for multiple operators related to the base station, corresponding shares partitioned from target resources available at the base station. Total resources available at the base station may be divided into a first part of resources dedicated for initial transmissions and a second part of resources dedicated for retransmissions. The RRP configuration may be applicable only to at least part of the first part of resources.

In an embodiment of the disclosure, the base station may be operative to perform the method according to the above third aspect.

According to a seventh aspect of the disclosure, there is provided a computer program product. The computer program product may comprise instructions which when executed by at least one processor, cause the at least one processor to perform the method according to any of the above first to third aspects.

According to an eighth aspect of the disclosure, there is provided a computer readable storage medium. The computer readable storage medium may store thereon instructions which when executed by at least one processor, cause the at least one processor to perform the method according to any of the above first to third aspects.

According to a ninth aspect of the disclosure, there is provided a first base station. The first base station may comprise a scheduling module for scheduling at least part of a plurality of terminal devices which require data transmissions using CA of a primary cell of the first base station and a secondary cell of a second base station, based on information related to a first RRP configuration and/or a second RRP configuration. The first/second RRP configuration may indicate, for multiple first/second operators related to the first/second base station, corresponding shares partitioned from target resources available at the first/second base station. The first base station may further comprise a sending module for sending a result of the scheduling to the second base station. Total resources available at the first/second base station may be divided into a first part of resources dedicated for initial transmissions and a second part of resources dedicated for retransmissions. The first/second RRP configuration may be applicable only to at least part of the first part of resources.

According to a tenth aspect of the disclosure, there is provided a second base station. The second base station may comprise a sending module for sending, to a first base station, information related to a second RRP configuration. The second RRP configuration may indicate, for multiple second operators related to the second base station, corresponding shares partitioned from target resources available at the second base station. The second base station may further comprise a reception module for receiving, from the first base station, a result of scheduling for one or more terminal devices which require data transmissions using CA of a primary cell of the first base station and a secondary cell of the second base station. Total resources available at the second base station may be divided into a first part of resources dedicated for initial transmissions and a second part of resources dedicated for retransmissions. The second RRP configuration may be applicable only to at least part of the first part of resources.

According to an eleventh aspect of the disclosure, there is provided a base station. The base station may comprise a scheduling module for scheduling at least part of a plurality of terminal devices requiring data transmissions, based on a RRP configuration that indicates, for multiple operators related to the base station, corresponding shares partitioned from target resources available at the base station. Total resources available at the base station may be divided into a first part of resources dedicated for initial transmissions and a second part of resources dedicated for retransmissions. The RRP configuration may be applicable only to at least part of the first part of resources.

According to a twelfth aspect of the disclosure, there is provided a method implemented in a communication system including a first base station and a second base station. The method may comprise steps of the method according to the above first aspect and steps of the method according to the above second aspect.

According to a thirteenth aspect of the disclosure, there is provided a communication system including a first base station according to the above fourth or ninth aspect and a second base station according to the above fifth or tenth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an exemplary communication system into which an embodiment of the disclosure is applicable;

FIG. 2 is a flowchart illustrating a method performed by a first base station according to an embodiment of the disclosure;

FIG. 3 is a diagram illustrating an exemplary example of cell resource splitting;

FIG. 4 is a flowchart for explaining the method of FIG. 2;

FIG. 5 is a flowchart illustrating a method performed by a first base station according to an embodiment of the disclosure;

FIG. 6 is a flowchart illustrating a method performed by a second base station according to an embodiment of the disclosure;

FIG. 7 is a flowchart illustrating a method performed by a second base station according to an embodiment of the disclosure;

FIG. 8 is a flowchart illustrating a method performed by a second base station according to an embodiment of the disclosure;

FIG. 9 is a flowchart illustrating a method performed by a base station according to an embodiment of the disclosure;

FIG. 10 is a flowchart for explaining the method of FIG. 9;

FIG. 11 is a flowchart illustrating a method performed by a base station according to an embodiment of the disclosure;

FIG. 12 is a block diagram showing an apparatus suitable for use in practicing some embodiments of the disclosure;

FIG. 13 is a block diagram showing a first base station according to an embodiment of the disclosure;

FIG. 14 is a block diagram showing a second base station according to an embodiment of the disclosure;

FIG. 15 is a block diagram showing a base station according to an embodiment of the disclosure;

FIG. 16 is diagram illustrating an example of a communication system in accordance with some embodiments;

FIG. 17 is a diagram illustrating a UE in accordance with some embodiments;

FIG. 18 is a diagram illustrating a network node in accordance with some embodiments;

FIG. 19 is a diagram illustrating a host in accordance with some embodiments;

FIG. 20 is a diagram illustrating a virtualization environment in which functions implemented by some embodiments may be virtualized;

FIG. 21 is a diagram illustrating a host communicating via a network node with a UE over a partially wireless connection in accordance with some embodiments;

FIG. 22 is a flowchart illustrating a method implemented in a communication system in accordance with some embodiments;

FIG. 23 is a flowchart illustrating a method implemented in a communication system in accordance with some embodiments;

FIG. 24 is a flowchart illustrating a method implemented in a communication system in accordance with some embodiments; and

FIG. 25 is a flowchart illustrating a method implemented in a communication system in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

Currently, either carrier aggregation (CA) or radio resource partition (RRP) is widely used. When RRP is deployed along with CA, it would be advantageous to solve the problem of how to handle RRP with CA and how to allocate resources among multiple operators flexibly. In addition, retransmission resources are impacted by RRP configuration in the existing solution, causing the inefficiency of resource utilization.

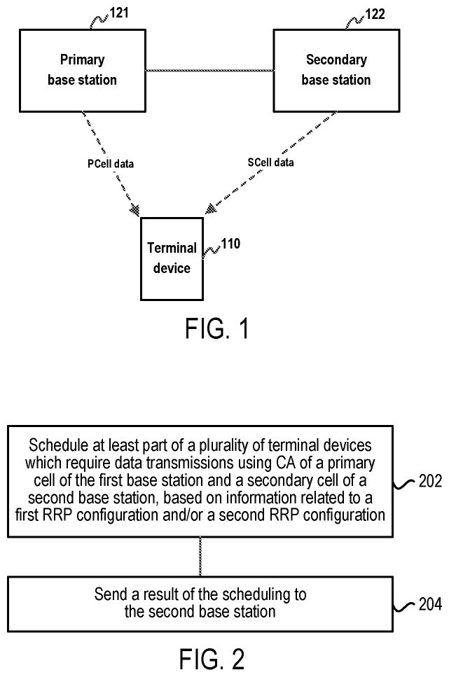

The present disclosure proposes an improved solution for scheduling terminal device. Hereinafter, the solution will be described in detail with reference to FIGS. 1-15.

FIG. 1 is a diagram illustrating an exemplary communication system into which an embodiment of the disclosure is applicable. As shown, the communication system comprises a terminal device 110, a primary base station 121 and a secondary base station 122. The term terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, the terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3rd generation partnership project (3GPP) context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

The terminal device 110 can communicate with the primary base station 121 and the secondary base station 122 by using carrier aggregation (CA). The CA technology was introduced in long term evolution advanced (LTE-A) system to achieve higher throughput than LTE system. According to the CA, a terminal device can communicate with a base station, simultaneously using a plurality of component carriers, thereby achieving broader bandwidth communication. The component carrier (CC) is used as a basic component and may have, for example, a maximum bandwidth of 20 MHz, which is supported by the LTE system. In the CA, a primary cell (PCell) and a secondary cell (SCell) are provided. The primary cell is similar to a serving cell in an LTE system, and serves as a cell to maintain connectivity between the terminal device and a network. The secondary cell is additionally configured for the terminal device which is accessing the primary cell.

In the CA up to LTE Release 10 (Rel-10), a terminal device uses a plurality of component carriers provided by a single base station for simultaneous communication. In Rel-12, the CA defined in Rel-10 is further extended so that dual connectivity is introduced, where a terminal device uses a plurality of component carriers provided by a plurality of base stations for simultaneous communication. In the dual connectivity, a base station corresponding to a primary cell may be referred to as a “master base station” and a base station corresponding to a secondary cell may be referred to as a “secondary base station”. For example, in FIG. 1, the terminal device 110 can receive PCell data and SCell data from the primary base station 121 and the secondary base station 122 respectively.

The term “base station (BS)” may refer to, for example, a node B (NodeB or NB), an evolved Node B (eNodeB or eNB), a next generation Node B or 5th generation (5G) Node B (gNodeB or gNB), a multi-standard radio (MSR) radio node such as an MSR BS, a master eNodeB (MeNB), a secondary eNodeB (SeNB), an integrated access backhaul (IAB) node, an access point (AP), a transmission point, a transmission reception point (TRP), a remote radio unit (RRU), a radio header (RH), a remote radio head (RRH), a relay, a low power node such as a femto, a pico, and so forth. For example, a base station may comprise a central unit (CU) including CU user plane (UP) and CU control plane (CP) and one or more distributed units (DUs). Thus, at least part of the base station mentioned herein may be implemented either on a dedicated hardware, as a software instance running on a dedicated hardware, or as a virtualized function instantiated on an appropriate platform, e.g. on a cloud infrastructure.

FIG. 2 is a flowchart illustrating a method performed by a first base station according to an embodiment of the disclosure. At block 202, the first base station schedules at least part of a plurality of terminal devices which require data transmissions using CA of a primary cell of the first base station and a secondary cell of a second base station, based on information related to a first RRP configuration and/or a second RRP configuration. The first RRP configuration indicates, for multiple first operators related to the first base station, corresponding shares partitioned from target resources available at the first base station. The second RRP configuration indicates, for multiple second operators related to the second base station, corresponding shares partitioned from target resources available at the second base station. Total resources available at the first base station are divided into a first part of resources dedicated for initial transmissions and a second part of resources dedicated for retransmissions, and the first RRP configuration is applicable only to at least part of the first part of resources. Total resources available at the second base station are divided into a first part of resources dedicated for initial transmissions and a second part of resources dedicated for retransmissions, and the second RRP configuration is applicable only to at least part of the first part of resources. At block 204, the first base station sends a result of the scheduling to the second base station. Because the first/second RRP configuration is not applicable to the second part of resources, the retransmission resources can be protected from being impacted by the RRP configuration.

The first base station may be a master base station in the CA, and the second base station may be a secondary base station in the CA. For example, the data transmissions required by the plurality of terminal devices may be downlink data transmissions in a scheduling queue in a scheduling event. The information related to the first RRP configuration may be maintained at the first base station and comprise at least one of: the first RRP configuration; and a second indicator indicating whether the primary cell of the first base station is configured to follow or ignore a resource partitioning request from the secondary cell of the second base station. The information related to the second RRP configuration may be received from the second base station and comprise at least one of: the second RRP configuration; and a first indicator indicating whether resource partitioning based on the second RRP configuration is requested by the second base station with respect to external resources for external usage of the CA.

For example, the share of a first/second operator may comprise at least one of: an expected share that is expected to be partitioned for the first/second operator from the target resources; and a maximum share that can be partitioned for the first/second operator from the target resources. A sum of the expected shares of the multiple first/second operators may be 100%. The maximum share of the first/second operator may be greater than the expected share of the first/second operator and smaller than or equal to 100%.

For example, the first part of resources may be divided into at least two partitions which comprise a base partition having a first priority and a normal partition having a second priority. The first priority is the highest priority among priorities of the at least two partitions. The first/second RRP configuration is applicable to the normal partition and not applicable to the base partition. Because the first/second RRP configuration is not applicable to the base partition, the resources for initial transmissions with the highest priority can be protected from being impacted by the RRP configuration.

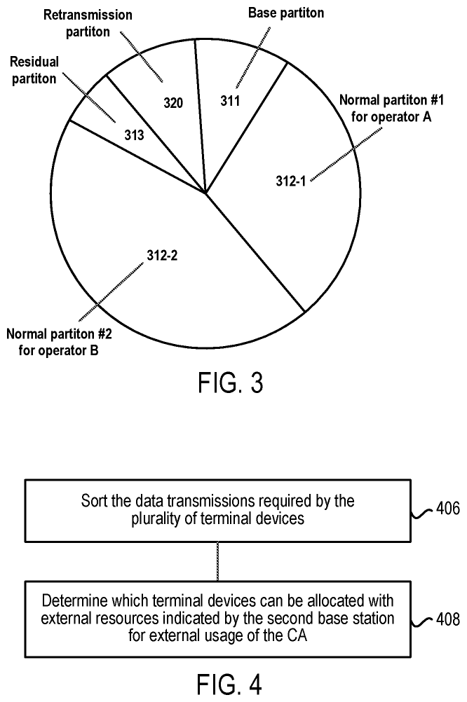

FIG. 3 illustrates an exemplary example of cell resource splitting. As shown, the total resources available at a base station (and thus, the total resources available at each cell of the base station) are divided into a first part of resources dedicated for initial transmissions and a second part 320 of resources dedicated for retransmissions. The first part of resources are divided into a base partition 311 having the highest priority, a normal partition 312-1, 312-2 having a medium priority, and a residual partition 313 having the lowest priority. The normal partition 312-1 corresponds to operator A, and the normal partition 312-2 corresponds to operator B. Thus, the RRP configuration is only applicable to the normal partition in this example. Note that the normal partition may be divided into more than two sub-partitions corresponding to different operators. The base partition 311 may comprise resources for one or more of: guaranteed bit rate (GBR) data radio bearers (DRBs); signaling radio bearers (SRB); priority paging (e.g. paging having high priority); scheduling requests; paging queue (PQ); etc. The normal partition may comprise resources for non-GBR DRBs. The residual partition 313 may comprise resources for prescheduling. Note that the specific proportions assigned to the four partitions (i.e. the retransmission partition, the base partition, the normal partition and the residual partition) and specific resources contained in respective partitions in FIG. 3 are merely exemplary example for illustration purpose, and they may be dynamically and flexibly configured depending on specific working conditions.

For example, block 202 may be implemented as blocks 406-408 of FIG. 4. At block 406, the first base station sorts the data transmissions required by the plurality of terminal devices. For instance, any existing or future developed techniques may be used to sort the data transmissions by assigning different weights (or priorities) to them. At block 408, the first base station determines which terminal devices can be allocated with external resources indicated by the second base station for external usage of the CA. The indicated external resources may be on the level of the secondary cell, but not on the level of the second base station. Thus, the present disclosure has no particular limitation in how to allocate resources by the second base station to respective cells of the second base station, as well as how to allocate the external resources by the secondary cell of the second base station to the primary cell of the first base station.

Blocks 406-408 may be implemented differently depending on different scenarios. In the first scenario, the multiple first operators (indicated by the first RRP configuration) are the same as the multiple second operators (indicated by the second RRP configuration), and the primary cell is configured to follow a resource partitioning request from the secondary cell (e.g. the first indicator indicates that resource partitioning based on the second RRP configuration is requested and the second indicator indicates that the primary cell is configured to follow a resource partitioning request from the secondary cell). For the first scenario, at least one of the plurality of terminal devices may be allocated with resources from the normal partition in the external resources. The at least one terminal device may be determined based on first operator(s) serving the plurality of terminal devices and maximum share(s) of corresponding second operator(s) which are same as the first operator(s) at block 408.

For example, if all of the plurality of terminal devices are served by the same first operator, then the data transmissions required by these terminal devices may be sequentially allocated with corresponding resources according to the sorted order, until the maximum share of the second operator which is same as the first operator is reached. If the plurality of terminal devices are served by different first operators, then as long as the maximum shares of corresponding second operators which are same as these first operators are not reached, the data transmissions required by these terminal devices may be sequentially allocated with corresponding resources according to the sorted order. In this way, since the maximum shares are used, the case where resources are available but could not be allocated to an operator due to the expected share of the operator having been reached can be avoided, thereby achieving flexible and efficient resource allocation. For the first scenario, the result of the scheduling sent to the second base station at block 204 may comprise, for the at least one terminal device, an ID identifying the corresponding second operator(s) in the normal partition of the external resources.

In the second scenario, the multiple first operators (indicated by the first RRP configuration) are different than the multiple second operators (indicated by the second RRP configuration) and the primary cell is configured to follow a resource partitioning request from the secondary cell (e.g. the first indicator indicates that resource partitioning based on the second RRP configuration is requested and the second indicator indicates that the primary cell is configured to follow a resource partitioning request from the secondary cell). For the second scenario, at least one terminal device, from one or more devices whose operator is indicated in the first and second RRP configurations, may be allocated with resources from the normal partition in the external resources. The at least one terminal device may be determined based on first operator(s) serving the one or more terminal devices and maximum share(s) of corresponding second operator(s) which are same as the first operator(s) at block 408. This may be implemented in a way similar to the above first scenario.

In addition, for the second scenario, one or more terminal devices whose operator is indicated in the first RRP configuration but not indicated in the second RRP configuration, may be sorted with a lowest priority at block 406. At least one of the one or more terminal devices may be allocated with resources from the base partition in the external resources. For example, the data transmissions required by the one or more terminal devices may be sequentially allocated with corresponding resources according to the sorted order. In this case, the result of the scheduling sent to the second base station at block 204 may comprise, for the at least one terminal device, an ID identifying the base partition in the external resources.

In the third scenario, the primary cell is configured to ignore a resource partitioning request from the secondary cell (e.g. the second indicator indicates that the primary cell is configured to ignore a resource partitioning request from the secondary cell, or there is no first RRP configuration configured for the primary cell, or the first indicator indicates that resource partitioning based on the second RRP configuration is not requested by the second base station). For the third scenario, at least one of the plurality of terminal devices is allocated with resources from the base partition in the external resources. For example, the data transmissions required by the plurality of terminal devices may be sequentially allocated with corresponding resources according to the sorted order. The result of the scheduling sent to the second base station at block 204 may comprise, for the at least one terminal device, an ID identifying the base partition in the external resources. For any one of the above three scenarios, the scheduling result may indicate, for each terminal device, the physical resource block (PRB) index, the transport block size (TBS), modulation and coding scheme (MCS), etc.

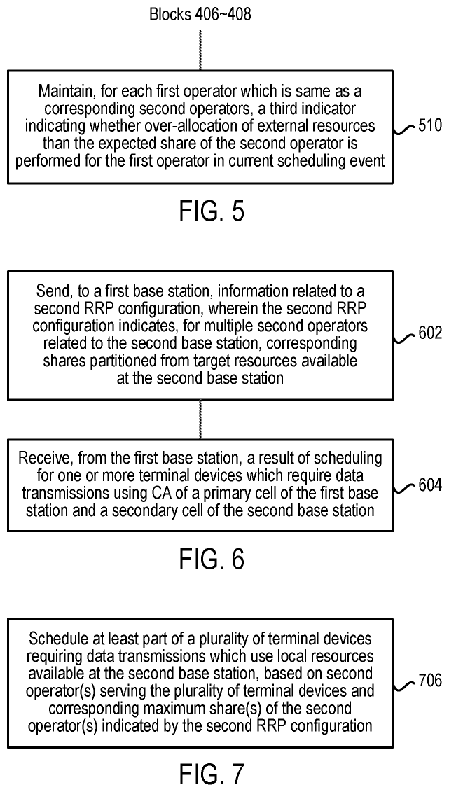

FIG. 5 is a flowchart illustrating a method performed by a first base station according to an embodiment of the disclosure. As shown, the method comprises blocks 406-408 described above and block 510. The method is applicable to the first scenario and second scenario described above with respect to blocks 406-408. At block 406, the first base station sorts the data transmissions required by the plurality of terminal devices. At block 408, the first base station determines which terminal devices can be allocated with external resources indicated by the second base station for external usage of the CA. In the first scenario, the multiple first operators are the same as the multiple second operators, and the primary cell is configured to follow a resource partitioning request from the secondary cell. For the first scenario, at least one of the plurality of terminal devices may be allocated with resources from the normal partition in the external resources. The at least one terminal device may be determined based on first operator(s) serving the plurality of terminal devices and maximum share(s) of corresponding second operator(s) which are same as the first operator(s) at block 408.

In the second scenario, the multiple first operators are different than the multiple second operators and the primary cell is configured to follow a resource partitioning request from the secondary cell. For the second scenario, at least one terminal device, from one or more devices whose operator is indicated in the first and second RRP configurations, may be allocated with resources from the normal partition in the external resources. The at least one terminal device may be determined based on first operator(s) serving the one or more terminal devices and maximum share(s) of corresponding second operator(s) which are same as the first operator(s) at block 408. This may be implemented in a way similar to the above first scenario.

At block 510, the first base station maintains, for each first operator which is same as a corresponding second operator, a third indicator indicating whether over-allocation of external resources than the expected share of the second operator is performed for the first operator in current scheduling event. For example, the third indicator may take a value of zero to indicate the over-allocation of external resources, or take a value of one to indicate no over-allocation of external resources. Initially, the third indicator for each first operator which is same as a corresponding second operator may be set to zero. Then, in a scheduling event, if any first operator which is same as a corresponding second operator is allocated with resources smaller than or equal to the expected share of the second operator, the third indicator for the first operator may be set to one.

Then, in the next scheduling event, terminal device(s) served by the first operator for which over-allocation of external resources is performed may be sorted (at block 406) with lower priorities than terminal device(s) served by the first operator for which no over-allocation of external resources is performed. This sorting can result in that terminal device(s) served by the first operator for which no over-allocation of external resources is performed are preferentially allocated with corresponding resources (at block 408), compared with the terminal device(s) served by the first operator for which over-allocation of external resources is performed. In this way, because the third indicators are used, the resources allocated to different operators can be relatively balanced.

As an exemplary example, suppose that there are six UEs (UE A-UE F) involved in the CA of the primary cell and the secondary cell and the two cells have the same operators (operator 1 and operator 2), where UEs A, B, C and F are served by operator 1 whose partitionID is 1, and UEs D and E are served by operator 2 whose partitionID is 2. In the initial scheduling event, the third indicators for operators 1 and 2 are initialized as zero. Suppose the sorting of the six UEs is as shown in Table 1 below.

TABLE 1
Sorting of the UEs in the initial scheduling event

| User | PartitionID | Weight | Third indicator |
|---|---|---|---|
| A | 1 | 100 | 0 |
| B | 1 | 90 | 0 |
| C | 1 | 85 | 0 |
| D | 2 | 80 | 0 |
| E | 2 | 70 | 0 |
| F | 1 | 60 | 0 |

Suppose that operator 1 in the primary cell is allocated with more resources than the expected share of operator 1 indicated in the RRP configuration of the secondary cell, while operator 2 in the primary cell is not allocated with more resources than the expected share of operator 2 indicated in the RRP configuration of the secondary cell in the initial scheduling event. Then, the third indicator for operator 2 is set to 1, while the third indicator for operator 1 remains to be 0. Suppose that there are data transmissions for all the UEs in the next scheduling event and weights remain the same as in the initial scheduling event. Then, the sorting of the six UEs may be as shown in Table 2 below.

TABLE 2
Sorting of the UEs in the next scheduling event

| User | PartitionID | Weight | Third indicator |
|---|---|---|---|
| D | 2 | 80 | 1 |
| E | 2 | 70 | 1 |
| A | 1 | 100 | 0 |
| B | 1 | 90 | 0 |
| C | 1 | 85 | 0 |
| F | 1 | 60 | 0 |

As a result, UEs D and E served by operator 2 can be preferentially allocated with resources compared with UEs A, B, C and F served by operator 1.

FIG. 6 is a flowchart illustrating a method performed by a second base station according to an embodiment of the disclosure. At block 602, the second base station sends, to a first base station, information related to a second RRP configuration. The second RRP configuration indicates, for multiple second operators related to the second base station, corresponding shares partitioned from target resources available at the second base station. Total resources available at the second base station are divided into a first part of resources dedicated for initial transmissions and a second part of resources dedicated for retransmissions, and the second RRP configuration is applicable only to at least part of the first part of resources. Because the second RRP configuration is not applicable to the second part of resources, the retransmission resources can be protected from being impacted by the RRP configuration.

The first base station may be a master base station in the CA, and the second base station may be a secondary base station in the CA. The information related to the second RRP configuration may comprise at least one of: the second RRP configuration; and a first indicator indicating whether resource partitioning based on the second RRP configuration is requested by the second base station with respect to external resources for external usage of the CA. For example, the share of a second operator may comprise at least one of: an expected share that is expected to be partitioned for the second operator from the target resources; and a maximum share that can be partitioned for the second operator from the target resources. A sum of the expected shares of the multiple second operators may be 100%. The maximum share of the second operator may be greater than the expected share of the second operator and smaller than or equal to 100%.

For example, the first part of resources may be divided into at least two partitions which comprise a base partition having a first priority and a normal partition having a second priority. The first priority is the highest priority among priorities of the at least two partitions. The second RRP configuration is applicable to the normal partition and not applicable to the base partition. Because the second RRP configuration is not applicable to the base partition, the resources for initial transmissions with the highest priority can be protected from being impacted by the RRP configuration.

At block 604, the second base station receives, from the first base station, a result of scheduling for one or more terminal devices which require data transmissions using CA of a primary cell of the first base station and a secondary cell of the second base station. For example, the data transmissions may be downlink data transmissions. Block 604 corresponds to block 204 and its details are omitted here.

FIG. 7 is a flowchart illustrating a method performed by a second base station according to an embodiment of the disclosure. At block 706, the second base station schedules at least part of a plurality of terminal devices requiring data transmissions which use local resources available at the second base station, based on second operator(s) serving the plurality of terminal devices and corresponding maximum share(s) of the second operator(s) indicated by the second RRP configuration. The second base station may be a secondary base station in the CA as described above with respect to block 602. For example, the data transmissions required by the plurality of terminal devices may be downlink data transmissions in a scheduling queue in a scheduling event. The second RRP configuration has been described above with respect to block 602.

For example, block 706 may be implemented as two sub-blocks. At the first sub-block, the second base station sorts the data transmissions required by the plurality of terminal devices. At the second sub-block, the second base station determines which terminal devices can be allocated with local resources, based on second operator(s) serving the plurality of terminal devices and corresponding maximum share(s) of the second operator(s) indicated by the second RRP configuration.

For example, at least one of the plurality of terminal devices may be allocated with resources from the normal partition in the local resources. If all of the plurality of terminal devices are served by the same second operator, then the data transmissions required by these terminal devices may be sequentially allocated with corresponding resources according to the sorted order, until the maximum share of the second operator is reached. If the plurality of terminal devices are served by different second operators, then as long as the maximum shares of these second operators are not reached, the data transmissions required by these terminal devices may be sequentially allocated with corresponding resources according to the sorted order. In this way, since the maximum shares are used, the case where resources are available but could not be allocated to an operator due to the expected share of the operator having been reached can be avoided, thereby achieving flexible and efficient resource allocation.

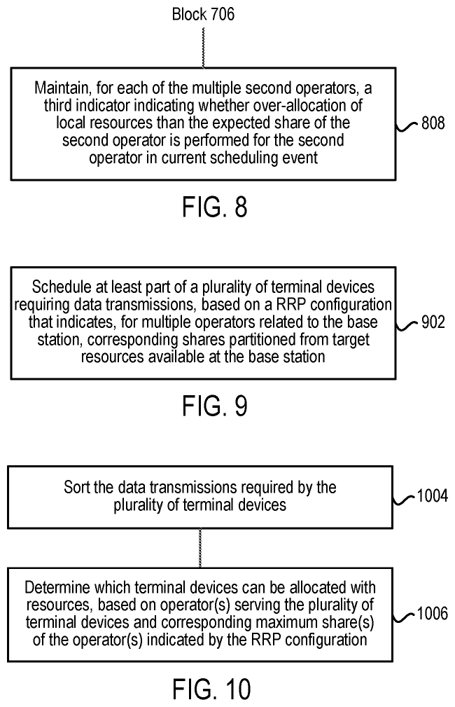

FIG. 8 is a flowchart illustrating a method performed by a second base station according to an embodiment of the disclosure. As shown, the method comprises block 706 described above and block 808. At block 706, the second base station schedules at least part of a plurality of terminal devices requiring data transmissions which use local resources available at the second base station, based on second operator(s) serving the plurality of terminal devices and corresponding maximum share(s) of the second operator(s) indicated by the second RRP configuration. At block 808, the second base station maintains, for each of the multiple second operators, a third indicator indicating whether over-allocation of local resources than the expected share of the second operator is performed for the second operator in current scheduling event. For example, the third indicator may take a value of zero to indicate the over-allocation of local resources, or take a value of one to indicate no over-allocation of local resources. Initially, the third indicator for each second operator may be set to zero. Then, in a scheduling event, if any second operator is allocated with resources smaller than or equal to the expected share of the second operator, the third indicator for the second operator may be set to one.

Then, in the next scheduling event, terminal device(s) served by the second operator for which over-allocation of local resources is performed may be scheduled (e.g. sorted) with lower priorities than terminal device(s) served by the second operator for which no over-allocation of local resources is performed. This sorting can result in that terminal device(s) served by the second operator for which no over-allocation of local resources is performed are preferentially allocated with corresponding resources, compared with the terminal device(s) served by the second operator for which over-allocation of local resources is performed. In this way, because the third indicators are used, the resources allocated to different operators can be relatively balanced. In addition, because the third indicators for the local resources (or local traffic) are maintained at the second base station independently from the third indicators for the external resources (or external traffic) which are maintained at the first base station, the resource allocation for the local traffic can be protected from being impacted by the resource allocation for the external traffic.

For ease of understanding, an inter-eNB CA will be taken as an example to explain the solutions described above. In this example, the first base station is a master eNB (which may be simply referred to as an MeNB), and the second base station is a secondary eNB (which may be simply referred to as an SeNB). The two base stations are connected via X2 interface. The cell resource splitting in each of the MeNB and the SeNB is as shown in FIG. 3. That is, the total cell resources are divided into retransmission partition, base partition, normal partition and residual partition. The partition configuration is only focused on the normal partition for new (or initial) transmissions to protect retransmission resources. An exemplary example of partition IDs corresponding to different partitions is shown in Table 3 below. Note that retransmission partition is omitted in Table 3 since the partition configuration is not applicable to the retransmission partition. The partition IDs “1” to “7” may correspond to different operators. In both the MeNB and the SeNB, the same partition ID for normal partition may represent the same operator.

TABLE 3
Partition IDs corresponding to different partitions

| Partition ID | Resource Part |
|---|---|
| 0 | Base partition |
| 1 | Normal partition |
| 2 | |
| 3 | |
| 4 | |
| 5 | |
| 6 | |
| 7 | |
| 8 | Residual partition |

In this example, when inter-eNB CA and RRP features are both active, the following two parameters (or attributes) are introduced. The first parameter may be called e.g. InterEnbCAPartitionMode (corresponding to the first indicator mentioned above) and have Enumeration data type which may take a value of 0 or 1. Based on this parameter, the customer related to the SeNB can define how the cell's resources used for external traffic are partitioned when inter-eNB CA is involved. The value 0 indicates “not partitioned” and may be the default value. This means the partitioning is not requested for the resources given for external usage, and thus, the external traffic will be handled through the base partition. The value 1 indicates “partitioned based on SCell's RRP configuration”. That is, the partitioning is requested for the resources given for external usage. Thus, the external traffic may be handled through the selected partition. Note that if RRP is not configured on the PCell, then the external traffic will still be assigned to the base partition at the SCell side, which will be described later.

The second parameter may be called e.g. InterEnbCAPartitionModeOverride and have Boolean data type which may take a value of 0 or 1. Based on this parameter, the customer related to the MeNB can define whether the PCell will follow or override the partitioning instruction received from the SCell when inter-eNB CA is involved. The value 0 may be the default value and indicates that the PCell will follow the received partitioning information from the SCell's RRP configuration. Based on the SCell's request, the PCell will partition or not the resources given for CA. The value 1 indicates that the PCell will ignore (or override) the received partitioning information from the SCell's RRP configuration. This means that all traffic will be handled through the base partition.

In addition, a leaky bucket algorithm is used in this example. This means that if a partition (corresponding to an operator) is over-utilized this time, its priority will be reduced in the next scheduling. Specifically, a leaky bucket flag (corresponding to the third indicator mentioned above) is introduced per partition (i.e. for each partition ID corresponding to an operator) per SCell (i.e. for each SCell involved in CA) on the MeNB for the resources given by the SCell from the SeNB. The leaky bucket flag for each partition ID corresponding to an operator may be initialized as 0. The partition usage (regarding the external resources) is tracked per partition per SCell. In a scheduling event, if any partition in which it is scheduled is not over-utilized, the leaky bucket flag of the partition is set to 1.

There may be three different scenarios. In Scenario 1, the PCell's configuration is the same as the Scell's configuration. Specifically, in the SCell, the RRP is configured and InterEnbCAPartitionMode=1. In the PCell, the RRP is configured and InterEnbCAPartitionModeOverride=0. The operators indicated in the PCell's RRP configuration are the same as the operators indicated in the SCell's RRP configuration. Thus, the Pcell and the SCell both have the same numbers of partitionIds.

For Scenario 1, at the PCell side, the resources given for external traffic are partitioned based on the SCell's RRP configuration. For example, scheduling entities (SEs) per SCell are sorted by their corresponding weights, wherein the scheduling entity is the unit for scheduling and may refer to every transmission with a certain quality of service (QoS) class. Then, SEs are selected and assigned with PRBs based on their corresponding partitionId(s) and configured resourcePartitionMaxShare (corresponding to the maximum share mentioned above) received from the SCell. In this example, according to the resourcePartitionMaxShare, the maximum resources that can be allocated for every SCell's transmission time interval (TTI) are fixed as 100% PRBs given by the SCell. Then, the leaky bucket flag is updated per partition per SCell. Then, the PCell provides the partitionId along with the PCell's scheduling result via the X2 interface. Note that SEs from a non-partitioned PCell are not partitioned, and their partitionID is set to 0, as described later.

For Scenario 1, at the SCell side, the SCell indicates the external resources to the Pcell. The RRP configuration of the SCell is also provided to the PCell via the X2 interface. Then, the SCell receives the scheduling result for the external traffic. The resource utilization of the local traffic and the resource utilization of the external traffic may be tracked respectively, but only the resource utilization of the local traffic is used for updating the leaky bucket flags at the SCell side. That is, the resource utilization of the external traffic is not considered for updating the leaky bucket flags at the SCell side.

In Scenario 2, the PCell's configuration is different from the SCell's configuration and the PCell follows the SCell's partitioning request. There may be two cases (Case 2-1 and Case 2-2) for Scenario 2. For Case 2-1, in the SCell, the RRP is configured and InterEnbCAPartitionMode=1. In the PCell, some partitionID is available on the SCell but not on the PCell, and InterEnbCAPartitionModeOverride=0. In Case 2-1, the processing performed by the PCell and the Scell is the same as that in Scenario 1.

For Case 2-2, in the SCell, the RRP is configured and InterEnbCAPartitionMode=1. In the PCell, some partitionID is available on the PCell but not on the SCell, and InterEnbCAPartitionModeOverride=0. In Case 2-2, at the PCell side, those SEs whose partitionID is available on the PCell but not on the SCell are always down-prioritized. These SEs are allocated with resources from the base partition in the external resources. Thus, the partitionID of these SEs is indicated as 0 in the scheduling result. In addition, for those SEs whose partitionID is available on both the PCell and the SCell, the processing performed by the PCell and the Scell is the same as that in Scenario 1.

In Scenario 3, the PCell does not follow the SCell's partitioning request. There may be three cases (Case 3-1, Case 3-2 and Case 3-3) for Scenario 3. For Case 3-1, In the SCell, the RRP is configured and InterEnbCAPartitionMode=1. In the PCell, the RRP is configured and InterEnbCAPartitionModeOverride=1. For Case 3-2, in the SCell, the RRP is configured and InterEnbCAPartitionMode=1. In the PCell, no RRP is configured. For Case 3-3, in the SCell, the RRP is configured and InterEnbCAPartitionMode=0. Thus, in the PCell, the RRP configuration becomes irrelevant since the SCell does not request resource partitioning based on its RRP configuration.

For any one of the above three cases in Scenario 3, at the PCell side, the resources given for external traffic are determined as without SCell's RRP configuration. Thus, at least one of the SEs in the scheduling queue is allocated with resources from the base partition in the external resources. Then, the scheduling result with partitionId=0 is sent to the SCell. Correspondingly, the SCell receives, from the PCell, the scheduling result with partitionId=0 for the external traffic. When tracking the resource usage for the base partition, the SCell may only calculate the resource utilization of the local traffic by excluding the resource utilization of the external traffic.

In the above exemplary example, different flexible solutions can be provided for the customers when there are various RRP configurations in the PCell and the SCell. It should be noted that the principle of the present disclosure may also be applicable to the case where dual connectivity is not involved.

FIG. 9 is a flowchart illustrating a method performed by a base station according to an embodiment of the disclosure. The method is applicable to a communication system including the base station and a terminal device. At block 902, the base station schedules at least part of a plurality of terminal devices requiring data transmissions, based on a RRP configuration that indicates, for multiple operators related to the base station, corresponding shares partitioned from target resources available at the base station. Total resources available at the base station are divided into a first part of resources dedicated for initial transmissions and a second part of resources dedicated for retransmissions, and the RRP configuration is applicable only to at least part of the first part of resources. Because the RRP configuration is not applicable to the second part of resources, the retransmission resources can be protected from being impacted by the RRP configuration.

For example, the data transmissions required by the plurality of terminal devices may be downlink data transmissions in a scheduling queue in a scheduling event. The share of an operator may comprise at least one of: an expected share that is expected to be partitioned for the operator from the target resources; and a maximum share that can be partitioned for the operator from the target resources. A sum of the expected shares of the multiple operators may be 100%. The maximum share of the operator may be greater than the expected share of the operator and smaller than or equal to 100%.

For example, the first part of resources may be divided into at least two partitions which comprise a base partition having a first priority and a normal partition having a second priority. The first priority is the highest priority among priorities of the at least two partitions. The RRP configuration is applicable to the normal partition and not applicable to the base partition. Because the RRP configuration is not applicable to the base partition, the resources for initial transmissions with the highest priority can be protected from being impacted by the RRP configuration.

For example, block 902 may be implemented as blocks 1004-1006 of FIG. 10. At block 1004, the base station sorts the data transmissions required by the plurality of terminal devices. At block 1006, the base station determines which terminal devices can be allocated with resources, based on operator(s) serving the plurality of terminal devices and corresponding maximum share(s) of the operator(s) indicated by the RRP configuration.

For example, at least one of the plurality of terminal devices may be allocated with resources from the normal partition in the resources available at the base station. If all of the plurality of terminal devices are served by the same operator, then the data transmissions required by these terminal devices may be sequentially allocated with corresponding resources according to the sorted order, until the maximum share of the operator is reached. If the plurality of terminal devices are served by different operators, then as long as the maximum shares of these operators are not reached, the data transmissions required by these terminal devices may be sequentially allocated with corresponding resources according to the sorted order. In this way, since the maximum shares are used, the case where resources are available but could not be allocated to an operator due to the expected share of the operator having been reached can be avoided, thereby achieving flexible and efficient resource allocation.

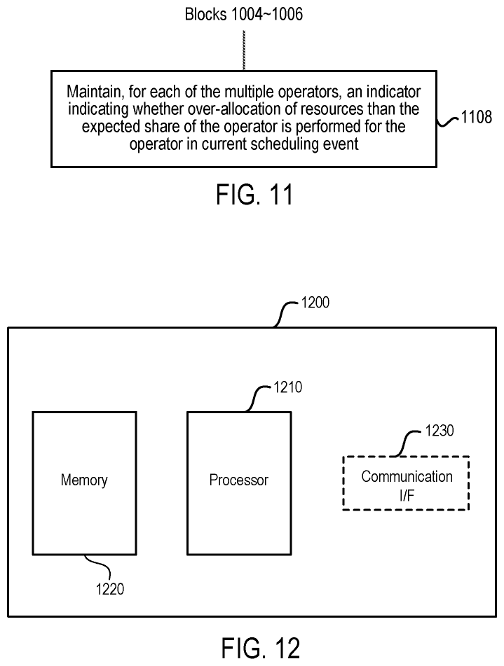

FIG. 11 is a flowchart illustrating a method performed by a base station according to an embodiment of the disclosure. As shown, the method comprises blocks 1004-1006 described above and block 1108. At block 1004, the base station sorts the data transmissions required by the plurality of terminal devices. At block 1006, the base station determines which terminal devices can be allocated with resources, based on operator(s) serving the plurality of terminal devices and corresponding maximum share(s) of the operator(s) indicated by the RRP configuration. At block 1108, the base station maintains, for each of the multiple operators, an indicator indicating whether over-allocation of resources than the expected share of the operator is performed for the operator in current scheduling event. For example, the third indicator may take a value of zero to indicate the over-allocation of resources, or take a value of one to indicate no over-allocation of resources. Initially, the third indicator for each operator may be set to zero. Then, in a scheduling event, if any operator is allocated with resources smaller than or equal to the expected share of the operator, the third indicator for the operator may be set to one.

Then, in the next scheduling event, terminal device(s) served by the operator for which over-allocation of resources is performed may be sorted (at block 1004) with lower priorities than terminal device(s) served by the operator for which no over-allocation of resources is performed. This sorting can result in that terminal device(s) served by the operator for which no over-allocation of resources is performed are preferentially allocated with corresponding resources (at block 1006), compared with the terminal device(s) served by the operator for which over-allocation of resources is performed. In this way, because the third indicators are used, the resources allocated to different operators can be relatively balanced.

FIG. 12 is a block diagram showing an apparatus suitable for use in practicing some embodiments of the disclosure. For example, any one of the first base station, the second base station and the base station described above may be implemented through the apparatus 1200. As shown, the apparatus 1200 may include a processor 1210, a memory 1220 that stores a program, and optionally a communication interface 1230 for communicating data with other external devices through wired and/or wireless communication.

The program includes program instructions that, when executed by the processor 1210, enable the apparatus 1200 to operate in accordance with the embodiments of the present disclosure, as discussed above. That is, the embodiments of the present disclosure may be implemented at least in part by computer software executable by the processor 1210, or by hardware, or by a combination of software and hardware.

The memory 1220 may be of any type suitable to the local technical environment and may be implemented using any suitable data storage technology, such as semiconductor based memory devices, flash memories, magnetic memory devices and systems, optical memory devices and systems, fixed memories and removable memories. The processor 1210 may be of any type suitable to the local technical environment, and may include one or more of general purpose computers, special purpose computers, microprocessors, digital signal processors (DSPs) and processors based on multi-core processor architectures, as non-limiting examples.

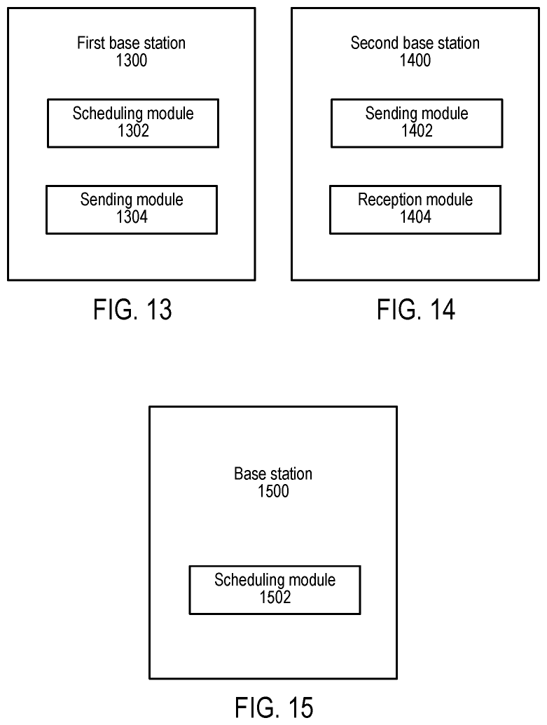

FIG. 13 is a block diagram showing a first base station according to an embodiment of the disclosure. As shown, the first base station 1300 comprises a scheduling module 1302 and a sending module 1304. The scheduling module 1302 may be configured to schedule at least part of a plurality of terminal devices which require data transmissions using CA of a primary cell of the first base station and a secondary cell of a second base station, based on information related to a first RRP configuration and/or a second RRP configuration, as described above with respect to block 202. The first/second RRP configuration may indicate, for multiple first/second operators related to the first/second base station, corresponding shares partitioned from target resources available at the first/second base station. The sending module 1304 may be configured to send a result of the scheduling to the second base station, as described above with respect to block 204. Total resources available at the first/second base station may be divided into a first part of resources dedicated for initial transmissions and a second part of resources dedicated for retransmissions. The first/second RRP configuration may be applicable only to at least part of the first part of resources.

FIG. 14 is a block diagram showing a second base station according to an embodiment of the disclosure. As shown, the second base station 1400 comprises a sending module 1402 and a reception module 1404. The sending module 1402 may be configured to send, to a first base station, information related to a second RRP configuration, as described above with respect to block 602. The second RRP configuration may indicate, for multiple second operators related to the second base station, corresponding shares partitioned from target resources available at the second base station. The reception module 1404 may be configured to receive, from the first base station, a result of scheduling for one or more terminal devices which require data transmissions using CA of a primary cell of the first base station and a secondary cell of the second base station, as described above with respect to block 604. Total resources available at the second base station may be divided into a first part of resources dedicated for initial transmissions and a second part of resources dedicated for retransmissions. The second RRP configuration may be applicable only to at least part of the first part of resources.

FIG. 15 is a block diagram showing a base station according to an embodiment of the disclosure. As shown, the base station 1500 comprises a scheduling module 1502. The scheduling module 1502 may be configured to schedule at least part of a plurality of terminal devices requiring data transmissions, based on a RRP configuration that indicates, for multiple operators related to the base station, corresponding shares partitioned from target resources available at the base station, as described above with respect to block 902. Total resources available at the base station may be divided into a first part of resources dedicated for initial transmissions and a second part of resources dedicated for retransmissions. The RRP configuration may be applicable only to at least part of the first part of resources. The modules described above may be implemented by hardware, or software, or a combination of both.

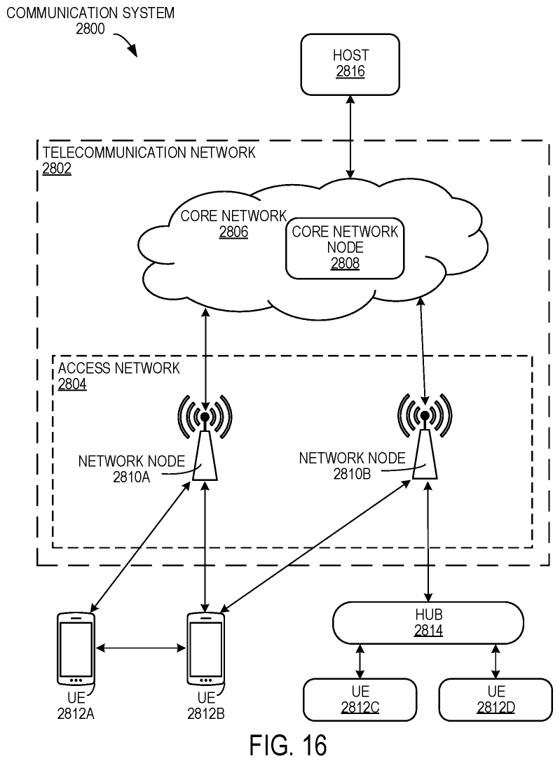

FIG. 16 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810b. In other embodiments, the hub 2814 may be a non-dedicated hub—that is, a device which is capable of operating to route communications between the UEs and network node 2810b, but which is additionally capable of operating as a communication start and/or end point for certain data channels.

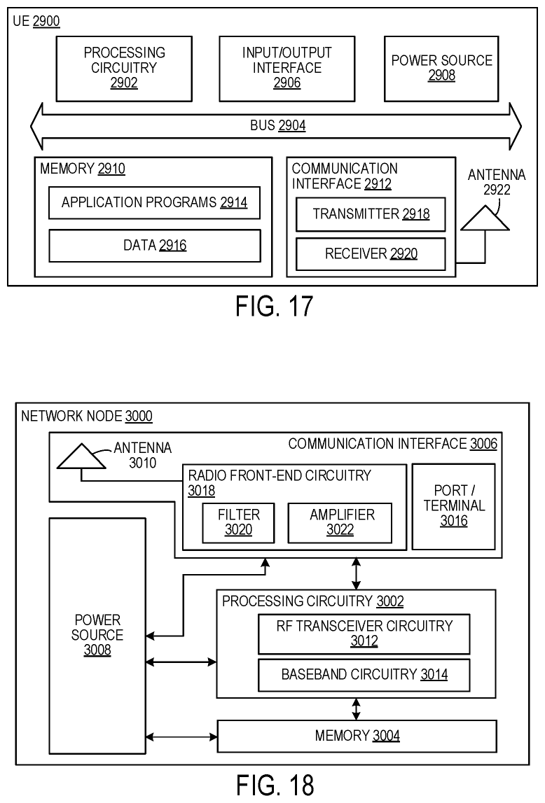

FIG. 17 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 18 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

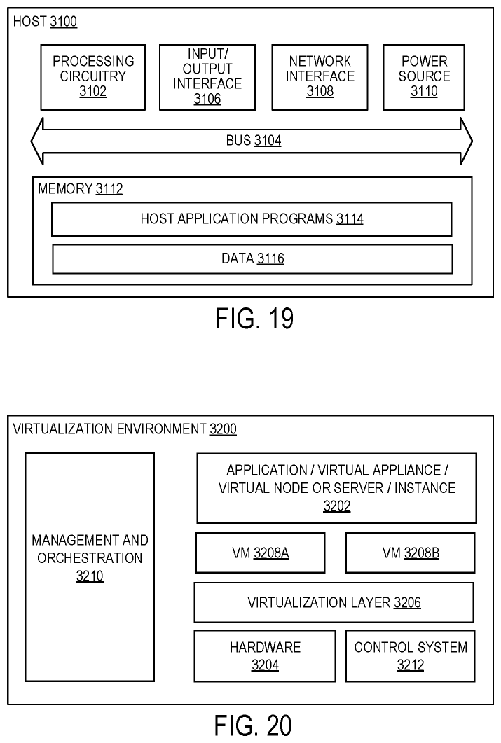

FIG. 19 is a block diagram of a host 3100, which may be an embodiment of the host 2816 of FIG. 16, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 17 and 18, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

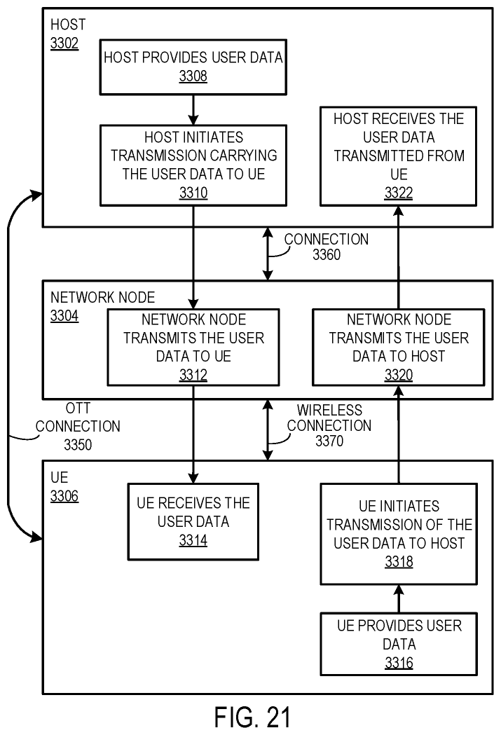

FIG. 21 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 16 and/or UE 2900 of FIG. 17), network node (such as network node 2810a of FIG. 16 and/or network node 3000 of FIG. 18), and host (such as host 2816 of FIG. 16 and/or host 3100 of FIG. 19) discussed in the preceding paragraphs will now be described with reference to FIG. 21.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 16) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may improve the latency and thereby provide benefits such as reduced user waiting time.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

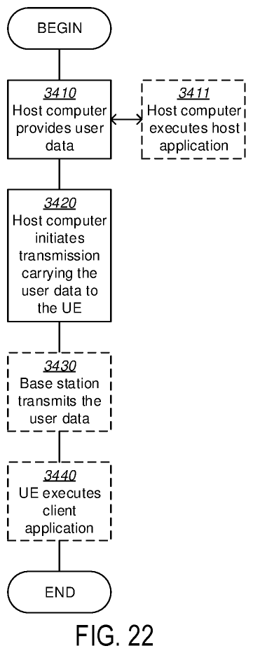

FIG. 22 is a flowchart illustrating a method implemented in a communication system, in accordance with one embodiment. The communication system includes a host computer, a base station and a UE which may be those described with reference to FIGS. 16 and 21. For simplicity of the present disclosure, only drawing references to FIG. 22 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

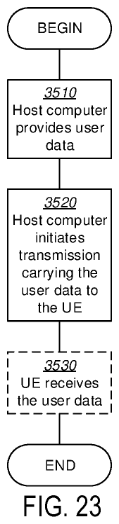

FIG. 23 is a flowchart illustrating a method implemented in a communication system, in accordance with one embodiment. The communication system includes a host computer, a base station and a UE which may be those described with reference to FIGS. 16 and 21. For simplicity of the present disclosure, only drawing references to FIG. 23 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

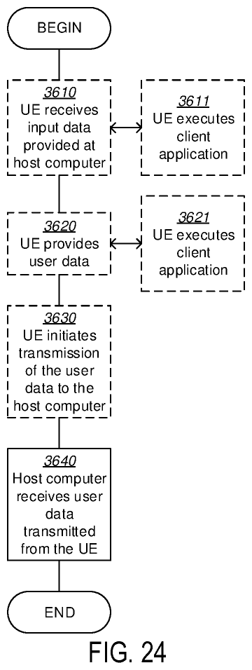

FIG. 24 is a flowchart illustrating a method implemented in a communication system, in accordance with one embodiment. The communication system includes a host computer, a base station and a UE which may be those described with reference to FIGS. 16 and 21. For simplicity of the present disclosure, only drawing references to FIG. 24 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

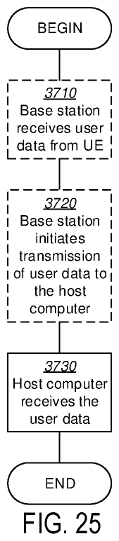

FIG. 25 is a flowchart illustrating a method implemented in a communication system, in accordance with one embodiment. The communication system includes a host computer, a base station and a UE which may be those described with reference to FIGS. 16 and 21. For simplicity of the present disclosure, only drawing references to FIG. 25 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

In an aspect of the disclosure, there is provided a method implemented in a communication system including a host computer, a first base station and a terminal device. The method may comprise, at the host computer, providing user data. The method may further comprise, at the host computer, initiating a transmission carrying the user data to the terminal device via a cellular network comprising the first base station. The first base station may schedule at least part of a plurality of terminal devices which require data transmissions using CA of a primary cell of the first base station and a secondary cell of a second base station, based on information related to a first RRP configuration and/or a second RRP configuration. The first/second RRP configuration may indicate, for multiple first/second operators related to the first/second base station, corresponding shares partitioned from target resources available at the first/second base station. The first base station may send a result of the scheduling to the second base station. Total resources available at the first/second base station may be divided into a first part of resources dedicated for initial transmissions and a second part of resources dedicated for retransmissions, and the first/second RRP configuration may be applicable only to at least part of the first part of resources.

In an embodiment of the disclosure, the method may further comprise, at the first base station, transmitting the user data.

In an embodiment of the disclosure, the user data may be provided at the host computer by executing a host application. The method may further comprise, at the terminal device, executing a client application associated with the host application.

In another aspect of the disclosure, there is provided a communication system including a host computer comprising processing circuitry configured to provide user data and a communication interface configured to forward the user data to a cellular network for transmission to a terminal device. The cellular network may comprise a first base station having a radio interface and processing circuitry. The first base station's processing circuitry may be configured to schedule at least part of a plurality of terminal devices which require data transmissions using CA of a primary cell of the first base station and a secondary cell of a second base station, based on information related to a first RRP configuration and/or a second RRP configuration. The first/second RRP configuration may indicate, for multiple first/second operators related to the first/second base station, corresponding shares partitioned from target resources available at the first/second base station. The first base station's processing circuitry may be further configured to send a result of the scheduling to the second base station. Total resources available at the first/second base station may be divided into a first part of resources dedicated for initial transmissions and a second part of resources dedicated for retransmissions, and the first/second RRP configuration may be applicable only to at least part of the first part of resources.

In an embodiment of the disclosure, the communication system may further include the first base station.

In an embodiment of the disclosure, the communication system may further include the terminal device. The terminal device may be configured to communicate with the first base station.

In an embodiment of the disclosure, the processing circuitry of the host computer may be configured to execute a host application, thereby providing the user data. The terminal device may comprise processing circuitry configured to execute a client application associated with the host application.

In yet another aspect of the disclosure, there is provided a method implemented in a communication system including a host computer, a first base station and a terminal device. The method may comprise, at the host computer, receiving, from the first base station, user data originating from a transmission which the first base station has received from the terminal device. The first base station may schedule at least part of a plurality of terminal devices which require data transmissions using CA of a primary cell of the first base station and a secondary cell of a second base station, based on information related to a first RRP configuration and/or a second RRP configuration. The first/second RRP configuration may indicate, for multiple first/second operators related to the first/second base station, corresponding shares partitioned from target resources available at the first/second base station. The first base station may send a result of the scheduling to the second base station. Total resources available at the first/second base station may be divided into a first part of resources dedicated for initial transmissions and a second part of resources dedicated for retransmissions, and the first/second RRP configuration may be applicable only to at least part of the first part of resources.

In an embodiment of the disclosure, the method may further comprise, at the first base station, receiving the user data from the terminal device.

In an embodiment of the disclosure, the method may further comprise, at first the base station, initiating a transmission of the received user data to the host computer.

In yet another aspect of the disclosure, there is provided a communication system including a host computer comprising a communication interface configured to receive user data originating from a transmission from a terminal device to a first base station. The first base station may comprise a radio interface and processing circuitry. The first base station's processing circuitry may be configured to schedule at least part of a plurality of terminal devices which require data transmissions using CA of a primary cell of the first base station and a secondary cell of a second base station, based on information related to a first RRP configuration and/or a second RRP configuration. The first/second RRP configuration may indicate, for multiple first/second operators related to the first/second base station, corresponding shares partitioned from target resources available at the first/second base station. The first base station's processing circuitry may be further configured to send a result of the scheduling to the second base station. Total resources available at the first/second base station may be divided into a first part of resources dedicated for initial transmissions and a second part of resources dedicated for retransmissions, and the first/second RRP configuration may be applicable only to at least part of the first part of resources.

In an embodiment of the disclosure, the communication system may further include the first base station.

In an embodiment of the disclosure, the communication system may further include the terminal device. The terminal device may be configured to communicate with the first base station.

In an embodiment of the disclosure, the processing circuitry of the host computer may be configured to execute a host application. The terminal device may be configured to execute a client application associated with the host application, thereby providing the user data to be received by the host computer.

In yet another aspect of the disclosure, there is provided a method implemented in a communication system including a host computer, a second base station and a terminal device. The method may comprise, at the host computer, providing user data.

The method may further comprise, at the host computer, initiating a transmission carrying the user data to the terminal device via a cellular network comprising the second base station. The second base station may send, to a first base station, information related to a second RRP configuration. The second RRP configuration may indicate, for multiple second operators related to the second base station, corresponding shares partitioned from target resources available at the second base station. The second base station may receive, from the first base station, a result of scheduling for one or more terminal devices which require data transmissions using CA of a primary cell of the first base station and a secondary cell of the second base station. Total resources available at the second base station may be divided into a first part of resources dedicated for initial transmissions and a second part of resources dedicated for retransmissions, and the second RRP configuration may be applicable only to at least part of the first part of resources.

In an embodiment of the disclosure, the method may further comprise, at the second base station, transmitting the user data.

In an embodiment of the disclosure, the user data may be provided at the host computer by executing a host application. The method may further comprise, at the terminal device, executing a client application associated with the host application.

In yet another aspect of the disclosure, there is provided a communication system including a host computer comprising processing circuitry configured to provide user data and a communication interface configured to forward the user data to a cellular network for transmission to a terminal device. The cellular network may comprise a second base station having a radio interface and processing circuitry. The second base station's processing circuitry may be configured to send, to a first base station, information related to a second RRP configuration. The second RRP configuration may indicate, for multiple second operators related to the second base station, corresponding shares partitioned from target resources available at the second base station. The second base station's processing circuitry may be further configured to receive, from the first base station, a result of scheduling for one or more terminal devices which require data transmissions using CA of a primary cell of the first base station and a secondary cell of the second base station. Total resources available at the second base station may be divided into a first part of resources dedicated for initial transmissions and a second part of resources dedicated for retransmissions, and the second RRP configuration may be applicable only to at least part of the first part of resources.

In an embodiment of the disclosure, the communication system may further include the second base station.

In an embodiment of the disclosure, the communication system may further include the terminal device. The terminal device may be configured to communicate with the second base station.

In an embodiment of the disclosure, the processing circuitry of the host computer may be configured to execute a host application, thereby providing the user data. The terminal device may comprise processing circuitry configured to execute a client application associated with the host application.

In yet another aspect of the disclosure, there is provided a method implemented in a communication system including a host computer, a second base station and a terminal device. The method may comprise, at the host computer, receiving, from the second base station, user data originating from a transmission which the second base station has received from the terminal device. The second base station may send, to a first base station, information related to a second RRP configuration. The second RRP configuration may indicate, for multiple second operators related to the second base station, corresponding shares partitioned from target resources available at the second base station. The second base station may receive, from the first base station, a result of scheduling for one or more terminal devices which require data transmissions using CA of a primary cell of the first base station and a secondary cell of the second base station. Total resources available at the second base station may be divided into a first part of resources dedicated for initial transmissions and a second part of resources dedicated for retransmissions, and the second RRP configuration may be applicable only to at least part of the first part of resources.

In an embodiment of the disclosure, the method may further comprise, at the second base station, receiving the user data from the terminal device.

In an embodiment of the disclosure, the method may further comprise, at the second base station, initiating a transmission of the received user data to the host computer.

In yet another aspect of the disclosure, there is provided a communication system including a host computer comprising a communication interface configured to receive user data originating from a transmission from a terminal device to a second base station. The second base station may comprise a radio interface and processing circuitry. The second base station's processing circuitry may be configured to send, to a first base station, information related to a second RRP configuration. The second RRP configuration may indicate, for multiple second operators related to the second base station, corresponding shares partitioned from target resources available at the second base station. The second base station's processing circuitry may be further configured to receive, from the first base station, a result of scheduling for one or more terminal devices which require data transmissions using CA of a primary cell of the first base station and a secondary cell of the second base station. Total resources available at the second base station may be divided into a first part of resources dedicated for initial transmissions and a second part of resources dedicated for retransmissions, and the second RRP configuration may be applicable only to at least part of the first part of resources.

In an embodiment of the disclosure, the communication system may further include the second base station.

In an embodiment of the disclosure, the communication system may further include the terminal device. The terminal device may be configured to communicate with the second base station.

In an embodiment of the disclosure, the processing circuitry of the host computer may be configured to execute a host application. The terminal device may be configured to execute a client application associated with the host application, thereby providing the user data to be received by the host computer.

In yet another aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The base station may schedule at least part of a plurality of terminal devices requiring data transmissions, based on a RRP configuration that indicates, for multiple operators related to the base station, corresponding shares partitioned from target resources available at the base station. Total resources available at the base station may be divided into a first part of resources dedicated for initial transmissions and a second part of resources dedicated for retransmissions, and the RRP configuration may be applicable only to at least part of the first part of resources.

In an embodiment of the disclosure, the method may further comprise, at the base station, transmitting the user data.

In an embodiment of the disclosure, the user data may be provided at the host computer by executing a host application. The method may further comprise, at the terminal device, executing a client application associated with the host application.

In yet another aspect of the disclosure, there is provided a communication system including a host computer comprising processing circuitry configured to provide user data and a communication interface configured to forward the user data to a cellular network for transmission to a terminal device. The cellular network may comprise a base station having a radio interface and processing circuitry. The base station's processing circuitry may be configured to schedule at least part of a plurality of terminal devices requiring data transmissions, based on a RRP configuration that indicates, for multiple operators related to the base station, corresponding shares partitioned from target resources available at the base station. Total resources available at the base station may be divided into a first part of resources dedicated for initial transmissions and a second part of resources dedicated for retransmissions, and the RRP configuration may be applicable only to at least part of the first part of resources.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application, thereby providing the user data. The terminal device may comprise processing circuitry configured to execute a client application associated with the host application.

In yet another aspect of the disclosure, there is provided a method implemented in a communication system including a host computer, a base station and a terminal device. The method may comprise, at the host computer, receiving, from the base station, user data originating from a transmission which the base station has received from the terminal device. The base station may schedule at least part of a plurality of terminal devices requiring data transmissions, based on a RRP configuration that indicates, for multiple operators related to the base station, corresponding shares partitioned from target resources available at the base station. Total resources available at the base station may be divided into a first part of resources dedicated for initial transmissions and a second part of resources dedicated for retransmissions, and the RRP configuration may be applicable only to at least part of the first part of resources.

In an embodiment of the disclosure, the method may further comprise, at the base station, receiving the user data from the terminal device.

In an embodiment of the disclosure, the method may further comprise, at the base station, initiating a transmission of the received user data to the host computer.

In yet another aspect of the disclosure, there is provided a communication system including a host computer comprising a communication interface configured to receive user data originating from a transmission from a terminal device to a base station. The base station may comprise a radio interface and processing circuitry. The base station's processing circuitry may be configured to schedule at least part of a plurality of terminal devices requiring data transmissions, based on a RRP configuration that indicates, for multiple operators related to the base station, corresponding shares partitioned from target resources available at the base station. Total resources available at the base station may be divided into a first part of resources dedicated for initial transmissions and a second part of resources dedicated for retransmissions, and the RRP configuration may be applicable only to at least part of the first part of resources.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a first base station, the method comprising:
scheduling at least part of a plurality of terminal devices which require data transmissions using carrier aggregation, CA, of a primary cell of the first base station and a secondary cell of a second base station, based on information related to a first radio resource partition, RRP, configuration and/or a second RRP configuration, the first/second RRP configuration indicating, for multiple first/second operators related to the first/second base station, corresponding shares partitioned from target resources available at the first/second base station;
sending a result of the scheduling to the second base station; and
total resources available at the first/second base station being divided into a first part of resources dedicated for initial transmissions and a second part of resources dedicated for retransmissions, and the first/second RRP configuration being applicable only to at least part of the first part of resources.

2. The method according to claim 1, wherein the first part of resources are divided into at least two partitions which comprise a base partition having a first priority and a normal partition having a second priority, the first priority is the highest priority among priorities of the at least two partitions, and the first/second RRP configuration is applicable to the normal partition and not applicable to the base partition.

3. The method according to claim 1, wherein the information related to the second RRP configuration is received from the second base station and comprises a first indicator indicating whether resource partitioning based on the second RRP configuration is requested by the second base station with respect to external resources for external usage of the CA; and
wherein the information related to the first RRP configuration is maintained at the first base station and comprises a second indicator indicating whether the primary cell of the first base station is configured to follow or ignore a resource partitioning request from the secondary cell of the second base station.

4. The method according to claim 2, wherein scheduling at least part of the plurality of terminal devices comprises:
sorting the data transmissions required by the plurality of terminal devices; and
determining which terminal devices can be allocated with external resources indicated by the second base station for external usage of the CA.

5. The method according to claim 4, wherein when the multiple first operators are different than the multiple second operators and the primary cell is configured to follow a resource partitioning request from the secondary cell, one or more terminal devices whose operator is indicated in the first RRP configuration but not indicated in the second RRP configuration, are sorted with a lowest priority;
at least one of the one or more terminal devices is allocated with resources from the base partition in the external resources; and
wherein the result of the scheduling sent to the second base station comprises, for the at least one terminal device, an identifier, ID, identifying the base partition in the external resources.

6. The method according to claim 4, wherein when the primary cell is configured to ignore a resource partitioning request from the secondary cell, at least one of the plurality of terminal devices is allocated with resources from the base partition in the external resources; and
wherein the result of the scheduling sent to the second base station comprises, for the at least one terminal device, an ID identifying the base partition in the external resources.

7. The method according to claim 4, wherein the share of a first/second operator comprises at least one of:
an expected share that is expected to be partitioned for the first/second operator from the target resources; and
a maximum share that can be partitioned for the first/second operator from the target resources, wherein the maximum share of the first/second operator is greater than the expected share of the first/second operator and smaller than or equal to 100%.

8. The method according to claim 7, wherein when the multiple first operators are the same as the multiple second operators and the primary cell is configured to follow a resource partitioning request from the secondary cell, at least one of the plurality of terminal devices is allocated with resources from the normal partition in the external resources; and
wherein the at least one terminal device is determined based on first operator(s) serving the plurality of terminal devices and maximum share(s) of corresponding second operator(s) which are same as the first operator(s).

9. The method according to claim 7, wherein when the multiple first operators are different than the multiple second operators and the primary cell is configured to follow a resource partitioning request from the secondary cell, at least one terminal device, from one or more devices whose operator is indicated in the first and second RRP configurations, is allocated with resources from the normal partition in the external resources; and
wherein the at least one terminal device is determined based on first operator(s) serving the one or more terminal devices and maximum share(s) of corresponding second operator(s) which are same as the first operator(s).

10. The method according to claim 8, further comprising:
maintaining, for each first operator which is same as a corresponding second operator, a third indicator indicating whether over-allocation of external resources than the expected share of the second operator is performed for the first operator in current scheduling event; and
wherein in a next scheduling event, terminal device(s) served by the first operator for which over-allocation of external resources is performed are sorted with lower priorities than terminal device(s) served by the first operator for which no over-allocation of external resources is performed.

11. A method performed by a second base station, the method comprising:
sending, to a first base station, information related to a second radio resource partition, RRP, configuration, the second RRP configuration indicating, for multiple second operators related to the second base station, corresponding shares partitioned from target resources available at the second base station;
receiving, from the first base station, a result of scheduling for one or more terminal devices which require data transmissions using carrier aggregation, CA, of a primary cell of the first base station and a secondary cell of the second base station; and
total resources available at the second base station being divided into a first part of resources dedicated for initial transmissions and a second part of resources dedicated for retransmissions, and the second RRP configuration being applicable only to at least part of the first part of resources.

12. The method according to claim 11, wherein the first part of resources are divided into at least two partitions which comprise a base partition having a first priority and a normal partition having a second priority, the first priority is the highest priority among priorities of the at least two partitions, and the second RRP configuration is applicable to the normal partition and not applicable to the base partition.

13. The method according to claim 11, wherein the information related to the second RRP configuration comprises a first indicator indicating whether resource partitioning based on the second RRP configuration is requested by the second base station with respect to external resources for external usage of the CA.

14. The method according to claim 12, wherein the share of a second operator comprises at least one of:
an expected share that is expected to be partitioned for the second operator from the target resources; and
a maximum share that can be partitioned for the second operator from the target resources, wherein the maximum share of the second operator is greater than the expected share of the second operator and smaller than or equal to 100%.

15. The method according to claim 14, further comprising:
scheduling at least part of a plurality of terminal devices requiring data transmissions which use local resources available at the second base station, based on second operator(s) serving the plurality of terminal devices and corresponding maximum share(s) of the second operator(s) indicated by the second RRP configuration.

16. The method according to claim 15, further comprising:
maintaining, for each of the multiple second operators, a third indicator indicating whether over-allocation of local resources than the expected share of the second operator is performed for the second operator in current scheduling event; and
wherein in a next scheduling event, terminal device(s) served by the second operator for which over-allocation of local resources is performed are scheduled with lower priorities than terminal device(s) served by the second operator for which no over-allocation of local resources is performed.

17. A method performed by a base station, the method comprising:
scheduling at least part of a plurality of terminal devices requiring data transmissions, based on a radio resource partition, RRP, configuration that indicates, for multiple operators related to the base station, corresponding shares partitioned from target resources available at the base station; and
total resources available at the base station being divided into a first part of resources dedicated for initial transmissions and a second part of resources dedicated for retransmissions, and the RRP configuration being applicable only to at least part of the first part of resources.

18. The method according to claim 17, wherein the first part of resources are divided into at least two partitions which comprise a base partition having a first priority and a normal partition having a second priority, the first priority is the highest priority among priorities of the at least two partitions, and the RRP configuration is applicable to the normal partition and not applicable to the base partition.

19. The method according to claim 18, wherein the share of an operator comprises at least one of:
an expected share that is expected to be partitioned for the operator from the target resources; and
a maximum share that can be partitioned for the operator from the target resources, wherein the maximum share of the operator is greater than the expected share of the operator and smaller than or equal to 100%.

20. The method according to claim 19, wherein scheduling at least part of the plurality of terminal devices comprises:
sorting the data transmissions required by the plurality of terminal devices; and
determining which terminal devices can be allocated with resources, based on operator(s) serving the plurality of terminal devices and corresponding maximum share(s) of the operator(s) indicated by the RRP configuration.

21.-28. (canceled)
